(19) United States
(12) Patent Application Publication
(10) Pub. No.: US 2024/0121158 A1
(43) Pub. Date: Apr. 11, 2024

(54) SCALABLE NETWORKING SYSTEMS AND PATCH PANELS

(71) Applicant: Mellanox Technologies, Ltd., Yokneam (IL)

(72) Inventors: Paraskevas Bakopoulos, Argiroupoli (GR); Dimitrios Kalavrouziotis, Papagos (GR); Nikolaos Argyris, Zografou (GR); Ioannis (Giannis) Patronas, Pireas (GR); Elad Mentovich, Tel Aviv (IL); Eitan Zahavi, Zichron Yaakov (IL); Prethvi Ramesh Kashinkunti, Chicago, IL (US); Louis Bennie Capps, JR., Georgetown, TX (US); Julie Irene Marcelle Bernauer, Palo Alto, CA (US); James Steven Fields, JR., Sante Fe, NM (US)

(21) Appl. No.: 17/984,424

(22) Filed: Nov. 10, 2022

(30) Foreign Application Priority Data
Oct. 11, 2022 (GR) 20220100836

(51) Int. Cl. H04L 41/12; H04L 49/45

(52) U.S. Cl. CPC H04L 41/12; H04L 49/45

(57) ABSTRACT

Apparatuses, systems, and methods are provided for scalable networking systems. An example system includes a plurality of core switches and a first stage patch panel associated with operation of a first set of network ports. In an operational configuration in which the first stage patch panel is coupled with the plurality of core switches, the first stage patch panel is configured to operatively couple the first set of network ports and a first portion of the plurality of core switches such that signals may pass therebetween. Furthermore, the first stage patch panel may preclude communication to a remaining portion of the plurality of core switches. The system may include a second stage patch panel associated with a second set of network ports that is operatively coupled with the plurality of core switches in the absence of the first stage patch panel so as to scale the networking system.

### CROSS-REFERENCE TO RELATED APPLICATIONS

This application claims priority to Greek Patent Application No. 20220100836, filed Oct. 11, 2022, the entire contents of which application are hereby incorporated herein by reference.

### TECHNOLOGICAL FIELD

Example embodiments of the present disclosure relate generally to network communication systems and, more particularly, to scalable networking systems.

### BACKGROUND

Communication networks, systems, channels, and the like are employed in a variety of applications in order to transmit data from one location to another. These networks may leverage a large number of interconnected network ports (e.g., electrical switches, core switches, host terminals, and/or the like) to provide these communications. As the number of network ports in an example network increases, the number of associated connections between these network ports similarly increases. Applicant has identified a number of deficiencies and problems associated with networking systems and associated communications. Through applied effort, ingenuity, and innovation, many of these identified problems have been solved by developing solutions that are included in embodiments of the present disclosure, many examples of which are described in detail herein.

### BRIEF SUMMARY

Systems, apparatuses, and methods are disclosed herein for scalable networking systems. An example scalable networking system may include a plurality of core switches and a first stage patch panel associated with operation of a first set of network ports. In an operational configuration in which the first stage patch panel is coupled with the plurality of core switches, the first stage patch panel may be configured to operatively couple the first set of network ports and a first portion of the plurality of core switches such that signals may pass therebetween and preclude communication to a remaining portion of the plurality of core switches.

In some embodiments, the plurality of core switches may be commonly housed within a datacenter rack.

In some further embodiments, the first stage patch panel may be removably attached with the datacenter rack.

In some embodiments, the scalable networking system may further include a second stage patch panel associated with operation of a second set of network ports.

In some further embodiments, the second set of network ports may include at least a portion of the first set of network ports. In such an embodiment, the second stage patch panel may be configured to be operatively coupled with the plurality of core switches in the absence of the first stage patch panel.

In some further embodiments, in an operational configuration in which the second stage patch panel is coupled with the plurality of core switches, the second stage patch panel may be configured to operatively couple the second set of network ports and a second portion of the plurality of core switches such that signals may pass therebetween and preclude communication to a remaining portion of the plurality of core switches.

In some still further embodiments, the second portion of the plurality of core switches may include at least a portion of the first portion of the plurality of core switches.

In some embodiments, the first stage patch panel may include a plurality of communication mediums configured to operatively couple the first set of network ports and the first portion of the plurality of core switches in the operational configuration.

In some further embodiments, the plurality of communication mediums comprise optical fibers, electrical traces, and/or electrical wires.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example network environment for implementing one or more embodiments of the present disclosure;

FIG. 2 illustrates an example first stage patch panel in accordance with one or more embodiments of the present disclosure;

FIG. 3 illustrates an example second stage patch panel in accordance with one or more embodiments of the present disclosure;

FIG. 4 illustrates an example third stage patch panel in accordance with one or more embodiments of the present disclosure;

FIG. 5 illustrates an example fourth stage patch panel in accordance with one or more embodiments of the present disclosure; and

FIG. 6 illustrates an example method for scaling a networking system in accordance with one or more embodiments of the present disclosure.

### DETAILED DESCRIPTION

### Overview

As described above, communication networks and systems are employed in a variety of applications in order to transmit data from one location to another. These networks may leverage a large number of interconnected network ports (e.g., electrical switches, core switches, host terminals, and/or the like) to provide these communications. For example, a networking system may include one or more network pods that are formed of network ports, such as in a leaf-spine architecture, where each network pod is communicably coupled with one or more core switches, core network ports, top layer switches, and/or the like. As the number of network ports in an example network increases, such as in the implementation of additional network pods, the number of associated connections between these network ports similarly increases.

An increase in the number of network connections often requires rewiring of at least a portion of the current connections to network ports within the networking system. By way of example, a networking system that includes a first network pod of network ports operatively connected with a collection of core switches may require half of these connections to be removed, rewired, etc. so as to operatively connect half of the core switches with the network ports of an example second network pod. As additional network pods each including numerous network ports are added to the networking system, further rewiring of core switches and associated network ports is required to integrate these additional network pods into the networking system. As such, conventional techniques for reconfiguring and/or scaling a networking system are time intensive and expensive. Furthermore, these techniques are prone to increased error due to the number of connections a user or operator is required to disconnect and reconnect as part of expanding or scaling the networking system to include additional network pods of network ports.

Thus, to address these and/or other issues, the embodiments of the present disclosure provide systems, devices, and methods that leverage patch panels configured to couple particular portions of a networks core switches. By way of example, a scalable networking system described herein may include a plurality of core switches and, at a first stage in the network's growth, a first stage patch panel. This first stage patch panel may be associated with a first set of network ports, such as the network ports that form a first network pod in the network and may operatively couple the first set of network ports and a first portion of the plurality of core switches such that signals may pass therebetween. In some instances, the first portion may refer to each of the core switches while in other instances the first stage patch panel may further preclude communication to a remaining portion of the plurality of core switches. As the network grows, expands, is reconfigured, etc. to include a second network pod of network ports, a second stage patch panel may instead be connected with the plurality of core switches (e.g., the second stage patch panel may replace the first stage patch panel).

The second stage patch panel may be associated operation of a second set of network ports that may also include the first set of network ports. In other words, the second stage patch panel may be configured for use with the first and second network pods of network ports or any number of network pods associated with the next stage of network growth. The second stage patch panel may operatively couple the second set of network ports (e.g., the first and the second network pod of network ports) and a second portion of the plurality of core switches such that signals may pass therebetween. Similar to the first stage patch panel, in some instances, the second portion may refer to each of the core switches while in other instances the second stage patch panel may further preclude communication to a remaining portion of the plurality of core switches (e.g. other than those connected with the first and second network pods). This process may be iteratively performed with each stage of network expansion (e.g., the inclusion of additional network pods of network ports) with respective stage patch panels used for each network stage. These stage-specific network panels are configured to operatively connect a particular collections of network ports (e.g., network pods of network ports) with a particular set of core switches without the need for rewiring of individual connections between particular network ports and core switches. In doing so, the embodiments of the present disclosure may provide scalable networking systems that remove the substantial rewiring requirement associated with conventional networking systems thereby reducing the financial burdens and error rates associated with networking system expansion.

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. Furthermore, as would be evident to one of ordinary skill in the art in light of the present disclosure, the terms “substantially” and “approximately” indicate that the referenced element or associated description is accurate to within applicable engineering tolerances.

As used herein, “operatively coupled” may mean that the components are electronically coupled and/or are in electrical communication with one another, or optically coupled and/or are in optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As described herein, network ports forming network pods may be referred to with reference to “input” and “output” network ports such that each network port pair includes a respective input network port and output network port. As such, the terms “input” and “output” are used merely for illustrative purposes in that the data, signals, information, and/or the like, that is transmitted by the network port pair may travel in either direction. In other words, an example input network port may operate as an output network port, and an example output network port may operate as an input network port. The present disclosure, therefore, contemplates that the network ports described herein may operate to transmit data, signals, and information to and receive data, signals, and information from any device communicably coupled thereto regardless of reference to input or output.

### Example Networking Environment

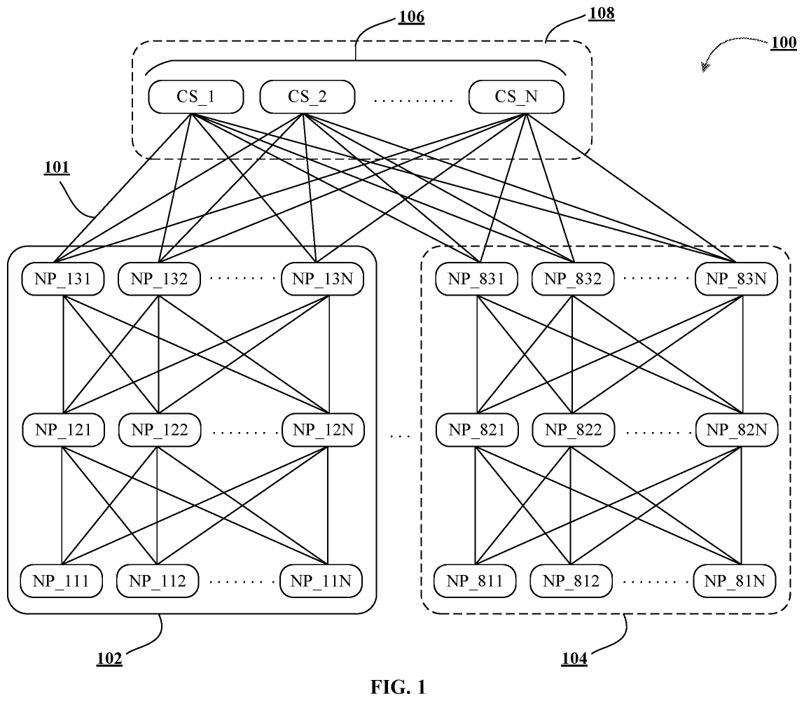

With reference to FIG. 1, an example network environment (e.g., scalable networking system 100) for implementing one or more embodiments of the present disclosure is illustrated. As shown, the system 100 may include a plurality of core switches 106 operatively coupled with one or more network pods (e.g., network pods 102, . . . , 104) where each pod is formed of a plurality of network ports. In the example implementation of FIG. 1, the system 100 includes eight (8) network pods with a first network pod 102 and an eighth network pod 104 illustrated (e.g., intervening second, third, fourth, etc. network pods not shown for brevity). The network pods (e.g., first network pod 102, . . . , eighth network 104, etc.) may be communicably coupled with one or more of the core switches 106. Although the scalable networking system techniques are described herein with reference to eight (8) network ports that are operatively coupled with eight (8) core switches 106, the present disclosure contemplates that the devices and techniques described herein may be applicable to networking systems with any number of network pods and core switches.

In some embodiments, each network pod (e.g., the first network pod 102, . . . , the eighth network pod 104) may be structured to have a multi-layer network architecture. Such a multi-layered architecture may be formed such that each layer includes a plurality of network ports by, with, and/or through which data, signals, information, and/or the like may be communicated. As such, the plurality of network ports may include any networking component or device, such as a switch, a server, a network interface controller (NIC), a networking card, a host terminal, and/or the like. Furthermore, the network pods (e.g., first network pod 102, . . . , the eighth network pod 104) may refer to any collection, portion, segment, etc. of network ports, cores, switches, etc. at the same or any combination of different network levels based upon the intended application of the system 100.

As shown in FIG. 1, each of the network pods may be formed of a plurality of network ports arranged in any number of layers, configurations, orientations, etc. For example, a first layer of the first network pod 102 may include network ports NP_111, NP_112 . . . NP_11N, a second layer of the first network pod 102 may include network ports NP_121, NP_122 . . . NP_12N, and a third layer of the first network pod 102 may include network ports NP_131, NP_132 . . . NP_13N. Each of the other network pods within the system may similarly include multiple network ports at different layers. For example, a first layer of the eighth network pod 104 may include network ports NP_811, NP_812 . . . NP_81N, a second layer of the eighth network pod 104 may include network ports NP_821, NP_822 . . . NP_82N, and a third layer of the eighth network pod 104 may include network ports NP_831, NP_832 . . . NP_83N. As described hereinafter, the particular network ports within the first network pod 102, . . . , and the eighth network pod 104 may vary in connection, network configuration, etc., and these connections may, in some embodiments, be dynamically modified during operation.

In some embodiments, the multi-layer network architecture may include a leaf-spine architecture or topology. A leaf-spine architecture is a data center network topology that may include two switching layers—a leaf layer (e.g., second layer), and a spine layer (e.g., third layer). The leaf layer may include leaf switches that aggregate traffic from host terminals and connect directly to the spine switches. Spine switches may interconnect leaf switches in a full or partial mesh topology, forming an access layer that delivers network connection points for the host terminals. As such, in some embodiments, the network ports NP_111, NP_112 . . . NP_11N in the first layer of the first network pod 102 may be host terminals, the network ports NP_121, NP_122 . . . NP_12N in the second layer of the first network pod 102 may be leaf switches, and the network ports NP_131, NP_132 . . . NP_13N in the third layer of the first network pod 102 may be spine switches. Although described herein with reference to a leaf-spine implementation, the present disclosure contemplates that the network pods and associated network ports may be formed in any network topology based upon the intended application of the networking system 100.

With continued reference to FIG. 1, the system 100 may further include a set of core switches CS_1, CS_2 . . . CS_N 106. In some embodiments, the set of cores switches CS_1, CS_2 . . . CS_N 106 may be high-capacity network ports that are positioned within the backbone or physical core of the network. The core switches CS_1, CS_2 . . . CS_N 106 may serve as the gateway to a wide area network (WAN) or the Internet, in that, they provide the final aggregation point for the network and allow multiple aggregation modules to work together. Although described hereinafter with reference to an implementation with eight (8) core switches operatively coupled with one or more network pods, the present disclosure contemplates that the system 100 may include any number of core switches 106 based upon the intended application of the system 100. Furthermore, FIG. 1 illustrates example communication mediums (e.g., optical fibers, electrical wires, electrical traces, etc.) by which communication between the network pods and the core switches 106 is established. The present disclosure contemplates that the system 100 may use any mechanism, technique, etc. to operatively couple, communicably connect, etc. the core switches 106 and the network pods. In some embodiments, the core switches 106 may be commonly housed within a datacenter rack 108.

The structure of the system 100 and its components, connections, relationships, and their functions, are provided as examples, and are not meant to limit implementations of the embodiments described. In one example, while the individual devices, such as network ports and core switches are defined to have specific functionality, the functionalities and terminology used to describe these devices may be flexible and interchangeable. In another example, the system 100 may include more, fewer, or different devices and/or components. In yet another example, some or all of the portions of the system 100 may be combined into a single portion or all of the portions of the system 100 may be separated into two or more distinct portions.

### Example Stage Patch Panels

As described above, an increase in the number of network connections in an example networking system traditionally requires rewiring of at least a portion of the current connections to network ports within the networking system. For example, the system 100 may, at a first time or stage in expansion of the network, include only the first network pod 102 operatively coupled with one or more of the core switches 106. For example, the network ports NP_131, NP_132, . . . , NP_13N of the first network pod 102 may be operatively coupled with each of the core switches 106. In traditional networking systems, these connections may be achieved via direct connections between the network ports NP_131, NP_132, . . . , NP_13N of the first network pod 102 and the core switches 106 via optical fibers or other communication mediums 101. When the networking system expands to a second or subsequent stage in which additional network pods are to be connected within the network, at least a portion of the connections between the network ports NP_131, NP_132, . . . , NP_13N of the first network pod 102 and the cores switches 106 are rewired to provide connectivity to the network ports of the subsequent or second network pod.

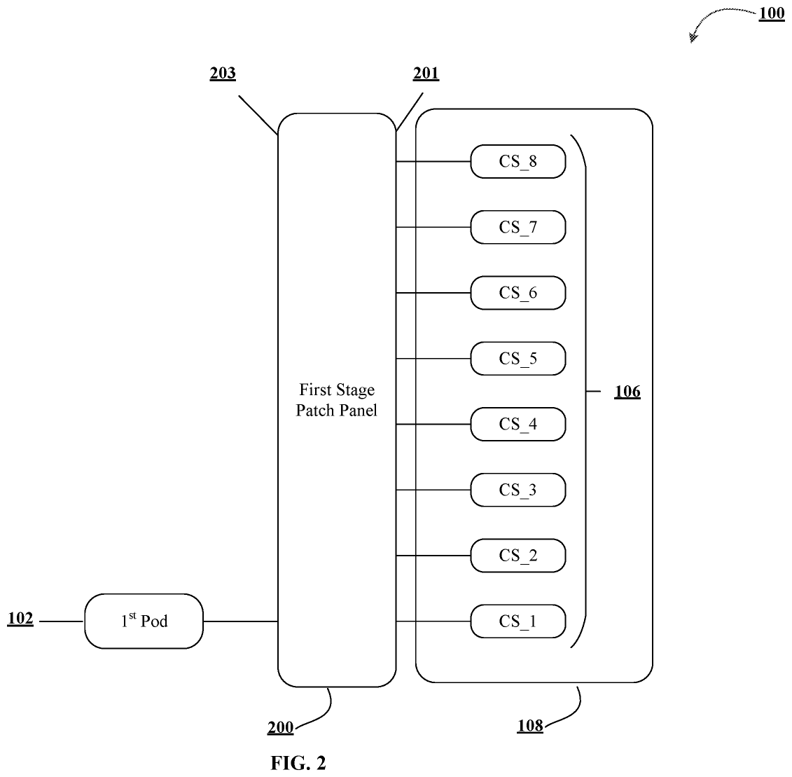

With reference to FIG. 2, the embodiments of the present disclosure provide a first stage patch panel 200 (e.g., first stage optical jumper) that may operate to prevent or reduce the rewiring burden associated with conventional networking systems when an initial number of networking pods are integrated into the system 100. As shown, the system 100 may include a plurality of core switches 106 that may be, for the sake of clarity, housed within a common datacenter rack 108. The datacenter rack 108 may, therefore, be dimensioned (e.g., sized and shaped) to accommodate the core switches 106 and may position and/or orient the core switches 106 based upon the intended application of the system 100. Although illustrated and described herein with reference to a single datacenter rack 108 supporting each of the plurality of core switches 106, the present disclosure contemplates that the core switches 106 may be supported by any number of distinct datacenter racks.

The system 100 may further include a first stage patch panel 200 associated with operation of a first set of network ports, such as the network ports of the first network pod 102. In some embodiments, the first stage patch panel 200 may be configured for removable attachment with the datacenter rack 108 such that the first stage patch panel 200 is physically coupled with the datacenter rack 108 in an operational configuration. In some embodiments, the operational configuration described hereinafter may refer to instances in which the first stage patch panel 200 is operatively connected with the first set of network ports (e.g., the first network pod 102) and at least a portion of the core switches 106 such that data may be transmitted therebetween regardless of the physical location of the first stage patch panel 200.

In an operational configuration in which the first stage patch panel 200 is coupled with the plurality of core switches 106, the first stage patch panel 200 may be configured to operatively couple the first set of network ports (e.g., the network ports of an example first network pod 102) and at least a first portion of the plurality of core switches 106 such that signals may pass therebetween. In some embodiments, the first stage patch panel 200 may operate to communicably couple the first set of network ports (e.g., the first network pod 102) with each of the core switches 106 such that the first portion of the plurality of the core switches 106 refers to each of the core switches 106. In such an embodiment, the first stage patch panel 200 may replace the traditional requirement of directly coupling the plurality of network ports (e.g., the first set of network ports) of the first network pod 102 with each of the core switches 106. In other words, the first stage patch panel 200 allows for the network ports of the plurality of network ports (e.g., the first set of network ports) of the first network pod 102 to be connected to the first stage patch panel 200 and for the first stage patch panel 200 to establish communication with the appropriate core switches 106 connected with the first stage patch panel 200. This communication by the first stage patch panel 200 may be accomplished by any number of associated communication mediums (e.g., optical fibers, electrical wires, electrical traces, etc.) and, in some embodiments, the first stage patch panel 200 may include a computing device, controller, etc. configured to at least partially direct communications.

In some embodiments, the first stage patch panel 200 may operate to communicably couple the first set of network ports (e.g., the first network pod 102) with a first portion of the core switches 106 that is less than the total number of core switches 106. In such an embodiment, the first stage patch panel 200 may establish communication with the appropriate core switches 106 connected with the first stage patch panel 200 that are configured for use with the plurality of network ports (e.g., the first set of network ports) of the first network pod 102 and preclude communication to a remaining portion of the plurality of core switches. This preclusion may be passive in nature, such as in instances in which the first stage patch panel 200 fails to include communication mediums for particular core switches, and/or may be active in nature, such as instances in which the first stage patch panel 200 includes a computing device that may selectively preclude signal transmission. The present disclosure contemplates that the number, portion, subset, etc. of core switches 106 operatively coupled with the first set of network ports (e.g., the network ports of the first network pod 102) may vary based upon the intended application of the system 100 and may, in some embodiments, varying dynamically during operation. For example, in some embodiments, the first stage patch panel 200 may be configured to actively provide and preclude communication to any number of core switches 106. Furthermore, in some embodiments, the first portion of the plurality of core switches 106 may refer to a portion of the total number of core switches 106 that may be used by the system 100. Said differently, the first set of network ports (e.g., the first network pod 102) may be configured for use with a first portion of the plurality of core switches 106, such as CS_1, such that the remaining core switches 106 are not required to be installed until additional network ports (e.g., the network pod 104 or the like) are added to the system 100. In this way, the system 100 may be capable of incremental deployment of core switches 106 based upon the number of network pods.

The first stage patch panel 200 may further include a housing or other structure that include a front panel 203 and/or a back panel 201. In such an example, the front panel 203 of the first stage patch panel 200 may be configured to operatively couple with the first set of network ports (e.g., the network ports of the first network pod 102). The back panel 201 may be configured to operatively couple with the plurality of core switches 106. The present disclosure, however, contemplates that any panel, surface, area, etc. of the first stage patch panel 200 may be configured to establish communication with the plurality of core switches 106 and/or the first set of network ports (e.g., the network ports of the first network pod 102). Furthermore, although illustrated and described herein with reference to a single housing, enclosure, structure, etc., the present disclosure contemplates that the patch panels (e.g., first stage patch panel 200, the second stage patch panel 202, the third stage patch panel 204, the fourth stage patch panel 206, etc.) may be formed of a plurality of components that are collectively referred to as a patch panel. In other words, the patch panel used for a particular stage of network expansion may, in some embodiments, refer to the plurality of patch panels used to provide network connectivity for the particular number of core switches 106 and network ports associated with that particular stage.

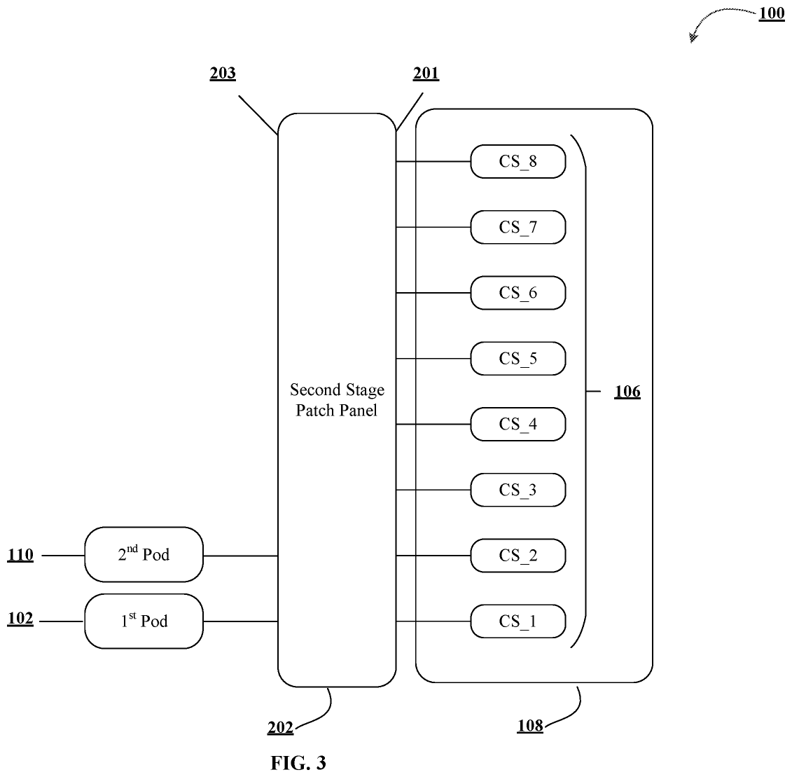

As the networking system 100 expands to include additional network ports of associated network pods at a second time or stage, the embodiments of the present disclosure may leverage a second stage patch panel 202 associated with operation of a second set of network ports as shown in FIG. 3. For example, the system 100 may include a second stage patch panel 202 that is associated with operation of network ports of a second network pod 110 and/or with the operation of the network ports of the first network pod 102. In other words, in some embodiments the second set of network ports may include at least a portion of the first set of network ports such that the second stage patch panel 202, and, in some embodiments, the second set of network ports may include all of the network ports of the first set of network ports. As would be evident to one of ordinary skill in the art in light of the present disclosure, the first and/or second set of network ports may include any network ports based upon the intended application of the networking system 100.

The second stage patch panel 202 may be configured to be operatively coupled with the plurality of core switches 106 in the absence of the first stage patch panel 200. Said differently, as the networking system 100 expands to include additional network ports (e.g., the network ports of the second network pod 110), the first stage patch panel 200 may be removed or otherwise replaced by the second stage patch panel 202. In doing so, the second stage patch panel 202 may be placed in an operational configuration in which the second stage patch panel 202 is coupled with the plurality of core switches 106. In the operational configuration, the second stage patch panel 202 may operatively couple the second set of network ports (e.g., the network ports of the second network pod 110 and/or the first network pod 102) and a second portion of the plurality of core switches 106 such that signals may pass therebetween.

In some embodiments, the second stage patch panel 202 may operate to communicably couple the second set of network ports (e.g., the first network pod 102 and the second network pod 110) with each of the core switches 106 such that the second portion of the plurality of the core switches 106 refers to each of the core switches 106. In such an embodiment, the second stage patch panel 202 may allow for the network ports of the plurality of network ports (e.g., the second set of network ports) of the first network pod 102 and the second network pod 110 to establish communication with the appropriate core switches 106 connected with the second stage patch panel 202. By way of a particular, non-limiting example, the second stage patch panel 202 may be configured to operatively couple the network ports of the first network pod 102 with half of the available core switches 106 and operatively couple the network ports of the second network pod 110 with the other half of the available core switches 106. This communication by the second stage patch panel 202 may similarly be accomplished by any number of associated communication mediums (e.g., optical fibers, electrical wires, electrical traces, etc.) and, in some embodiments, the second stage patch panel 202 may also include a computing device, controller, etc. configured to at least partially direct communications.

In some embodiments, the second stage patch panel 202 may operate to communicably couple the second set of network ports (e.g., the first network pod 102 and the second network pod 110) with a second portion of the core switches 106 that is less than the total number of core switches 106. In such an embodiment, the second stage patch panel 202 may establish communication with the appropriate core switches 106 connected with the second stage patch panel 202 that are configured for use with the plurality of network ports (e.g., the second set of network ports) of the network pods 102, 110 and preclude communication to a remaining portion of the plurality of core switches 106. This preclusion may be active or passive in nature as described above with reference to FIG. 2.

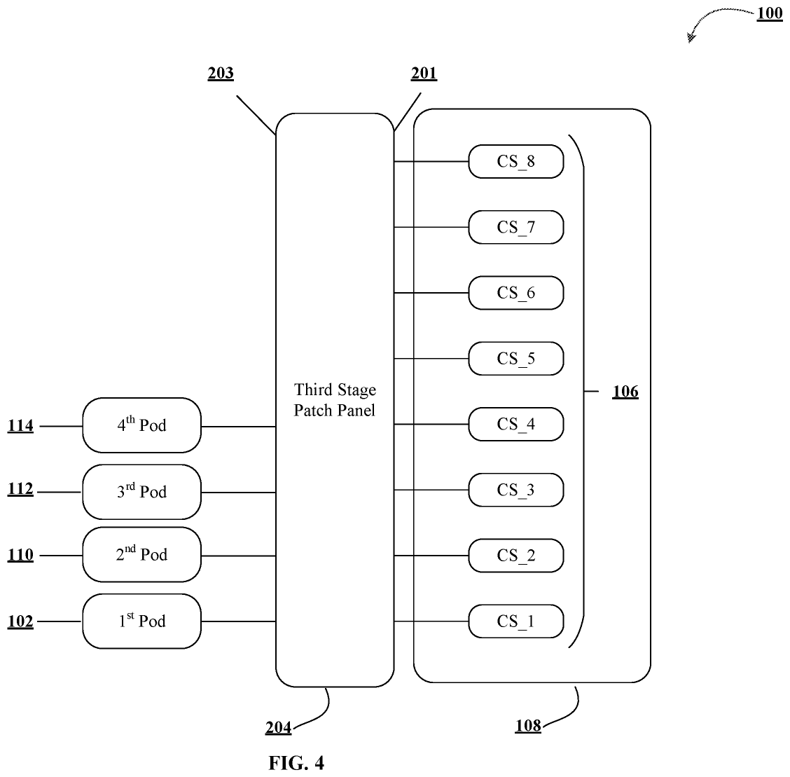

As the networking system 100 further expands to include additional network ports of associated network pods at a third time or stage, the embodiments of the present disclosure may leverage a third stage patch panel 204 associated with operation of a third set of network ports as shown in FIG. 4. For example, the system 100 may include a third stage patch panel 204 that is associated with operation of network ports of a fourth network pod 114, a third network pod 112, the second network pod 110, and/or the first network pod 102. In other words, in some embodiments the third set of network ports may include at least a portion of the first set of network ports and the second set of network ports such that the third stage patch panel 204, and, in some embodiments, the third set of network ports may include all of the network ports of the second and first sets of network ports. As would be evident to one of ordinary skill in the art in light of the present disclosure, the third set of network ports may include any network ports based upon the intended application of the networking system 100.

The third stage patch panel 204 may be configured to be operatively coupled with the plurality of core switches 106 in the absence of the second stage patch panel 202. Said differently, as the networking system 100 expands to include additional network ports, the second stage patch panel 202 may be removed or otherwise replaced by the third stage patch panel 204. In doing so, the third stage patch panel 204 may be placed in an operational configuration in which the third stage patch panel 204 is coupled with the plurality of core switches 106. In the operational configuration, the third stage patch panel 204 may operatively couple the third set of network ports (e.g., the network ports of the fourth, third, second, and first network pods 114, 112, 110, 102) and a third portion of the plurality of core switches 106 such that signals may pass therebetween.

In some embodiments, the third stage patch panel 204 may operate to communicably couple the third set of network ports (e.g., the network pods 114, 112, 110, 102) with each of the core switches 106 such that the third portion of the plurality of the core switches 106 refers to each of the core switches 106. In such an embodiment, the third stage patch panel 204 may allow for the network ports of the plurality of network ports (e.g., the third set of network ports) of the network pods 114, 112, 110, 102 to establish communication with the appropriate core switches 106 connected with the third stage patch panel 204. By way of a particular, non-limiting example, the third stage patch panel 204 may be configured to operatively couple the network ports of the each of the network pods 114, 112, 110, 102 with a quarter of the available core switches 106. This communication by the third stage patch panel 204 may similarly be accomplished by any number of associated communication mediums (e.g., optical fibers, electrical wires, electrical traces, etc.) and, in some embodiments, the third stage patch panel 204 may also include a computing device, controller, etc. configured to at least partially direct communications.

In some embodiments, the third stage patch panel 204 may operate to communicably couple the third set of network ports (e.g., the network pods 114, 112, 110, 102) with a third portion of the core switches 106 that is less than the total number of core switches 106. In such an embodiment, the third stage patch panel 204 may establish communication with the appropriate core switches 106 connected with the third stage patch panel 204 that are configured for use with the plurality of network ports (e.g., the third set of network ports) of the network pods 114, 112, 110, 102 and preclude communication to a remaining portion of the plurality of core switches 106. This preclusion may be active or passive in nature as described above with reference to FIG. 2.

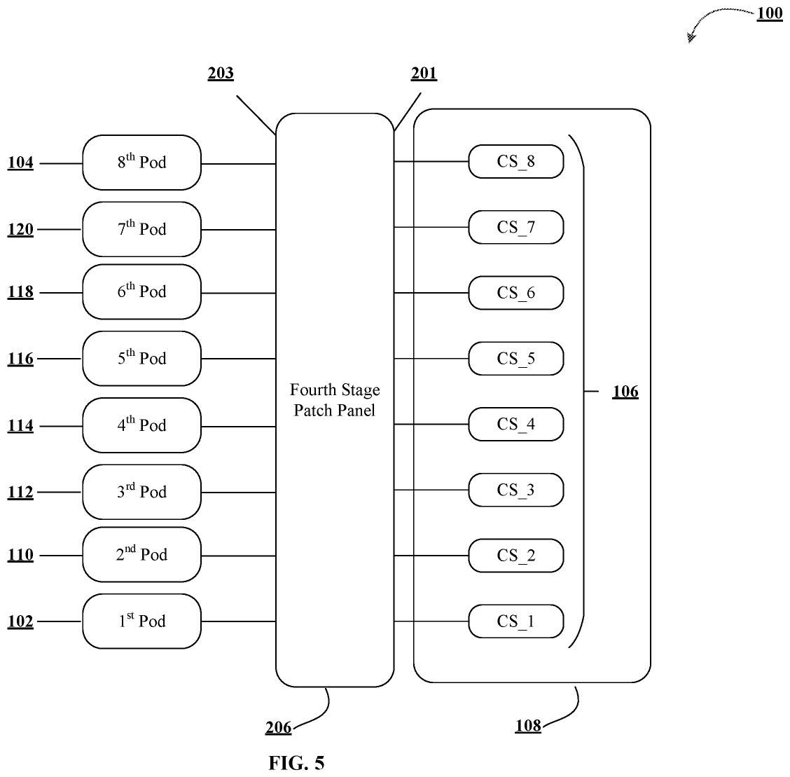

As the networking system 100 further expands to include additional network ports of associated network pods at a fourth time or stage, the embodiments of the present disclosure may leverage a fourth stage patch panel 206 associated with operation of a fourth set of network ports as shown in FIG. 5. For example, the system 100 may include a fourth stage patch panel 206 that is associated with operation of network ports of the eighth network pod 104, a seventh network pod 120, a sixth network pod 118, a fifth network pod 116, the fourth network pod 114, the third network pod 112, the second network pod 110, and/or the first network pod 102. In other words, in some embodiments the fourth set of network ports may include at least a portion of the first set of network ports, the second set of network ports, and/or the third set of network ports such that the fourth stage patch panel 206, and, in some embodiments, the fourth set of network ports may include all of the network ports of the networking system 100. As would be evident to one of ordinary skill in the art in light of the present disclosure, the fourth set of network ports may include any network ports based upon the intended application of the networking system 100.

The fourth patch panel 206 may be configured to be operatively coupled with the plurality of core switches 106 in the absence of the third stage patch panel 204. Said differently, as the networking system 100 expands to include additional network ports, the third stage patch panel 204 may be removed or otherwise replaced by the fourth stage patch panel 206. In doing so, the fourth stage patch panel 206 may be placed in an operational configuration in which the fourth stage patch panel 206 is coupled with the plurality of core switches 106. In the operational configuration, the fourth stage patch panel 206 may operatively couple the fourth set of network ports (e.g., the network ports of the network pods 104, 120, 118, 116, 114, 112, 110, 102) and a fourth portion of the plurality of core switches 106 such that signals may pass therebetween.

In some embodiments, the fourth stage patch panel 206 may operate to communicably couple the fourth set of network ports (e.g., the network pods 104, 120, 118, 116, 114, 112, 110, 102) with each of the core switches 106 such that the fourth portion of the plurality of the core switches 106 refers to each of the core switches 106. In such an embodiment, the fourth stage patch panel 206 may allow for the network ports of the plurality of network ports (e.g., the fourth set of network ports) of the network pods 104, 120, 118, 116, 114, 112, 110, 102 to establish communication with the appropriate core switches 106 connected with the fourth stage patch panel 206. By way of a particular, non-limiting example, the fourth stage patch panel 206 may be configured to operatively couple the network ports of the each of the network pods 104, 120, 118, 116, 114, 112, 110, 102 with an eighth (e.g., one of the available eight (8)) of the available core switches 106. This communication by the fourth stage patch panel 206 may similarly be accomplished by any number of associated communication mediums (e.g., optical fibers, electrical wires, electrical traces, etc.) and, in some embodiments, the fourth stage patch panel 206 may also include a computing device, controller, etc. configured to at least partially direct communications.

As would be evident in light of the present disclosure, the fourth stage of the expansion of the networking system 100 may substantially refer to the maximum capacity of the networking system 100 with regard to network ports. Although described herein with reference to a four (4) stage expansion of the networking system 100 in which each subsequent stage doubled the number of network pods operatively coupled with the core switches from the prior stage, the present disclosure contemplates that the staged patch panels and associated methods described herein may include any number of stages and associated network pods of network ports based upon the intended application of the networking system 100. Furthermore, the present disclosure contemplates that the staged patch panels described herein may be similarly used to downsize or contract the size of the networking system 100 without requiring additional rewiring of network ports.

### Example Methods for Scaling Networking Systems

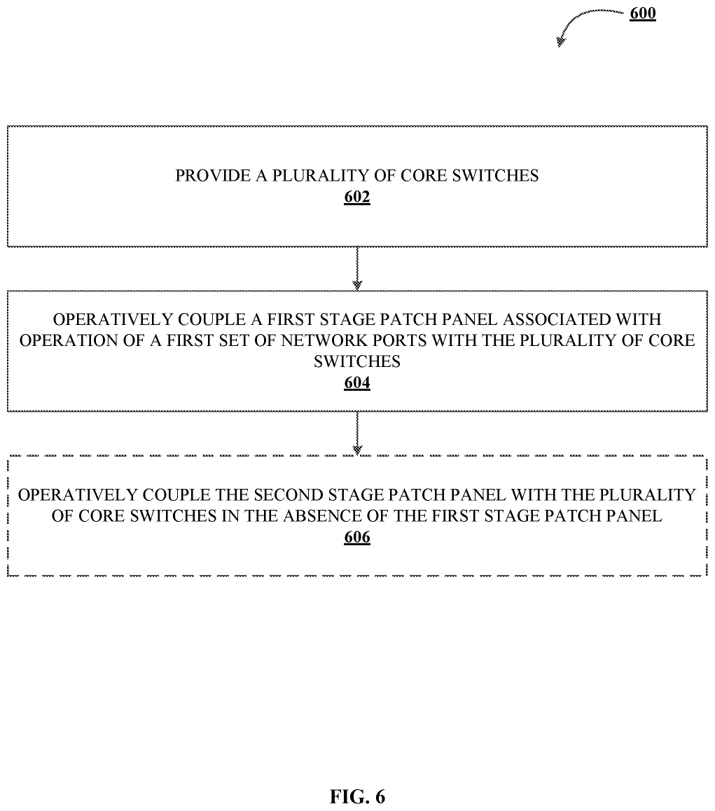

With reference to FIG. 6, an example method (e.g. method 600) for scalable networking systems is illustrated. As shown in Block 602, the method may include providing a plurality of core switches. As described above, the set of cores switches may be high-capacity network ports that are positioned within the backbone or physical core of the network. The core switches may serve as the gateway to a wide area network (WAN) or the Internet, in that, they provide the final aggregation point for the network and allow multiple aggregation modules to work together. Although described herein with reference to an implementation with eight (8) core switches operatively coupled with one or more network pods, the present disclosure contemplates that the system may include any number of core switches based upon the intended application of the system. In some embodiments, the core switches may be commonly housed within a datacenter rack.

The method 600 may further include operatively coupling a first stage patch panel associated with operation of a first set of network ports with the plurality of core switches as shown in Block 604. As described above, the first stage patch panel (e.g., first stage optical jumper) may operate to prevent or reduce the rewiring burden associated with conventional networking systems when an initial number of networking pods are integrated into the system. The first stage patch panel may be associated with operation of a first set of network ports, such as the network ports of the first network pod. In some embodiments, the first stage patch panel may be configured for removable attachment with the datacenter rack such that the first stage patch panel is physically coupled with the datacenter rack in an operational configuration.

In an operational configuration in which the first stage patch panel is coupled with the plurality of core switches, the first stage patch panel may be configured to operatively couple the first set of network ports (e.g., the network ports of an example first network pod) and at least a first portion of the plurality of core switches such that signals may pass therebetween. In some embodiments, the first stage patch panel may operate to communicably couple the first set of network ports (e.g., the first network pod) with each of the core switches such that the first portion of the plurality of the core switches refers to each of the core switches. In such an embodiment, the first stage patch panel may replace the traditional requirement of directly coupling the plurality of network ports (e.g., the first set of network ports) of the first network pod with each of the core switches. In other embodiments, the first stage patch panel may operate to communicably couple the first set of network ports (e.g., the first network pod) with a first portion of the core switches that is less than the total number of core switches.

In some embodiments, as shown in Block 606, the method may include operatively coupling the second stage patch panel with the plurality of core switches in the absence of the first stage patch panel. As described above, as the networking system expands to include additional network ports of associated network pods at a second time or stage, the embodiments of the present disclosure may leverage a second stage patch panel associated with operation of a second set of network ports. The system may include a second stage patch panel that is associated with operation of network ports of a second network pod and/or with the operation of the network ports of the first network pod. In other words, in some embodiments the second set of network ports may include at least a portion of the first set of network ports such that the second stage patch panel, and, in some embodiments, the second set of network ports may include all of the network ports of the first set of network ports.

The second stage patch panel may be configured to be operatively coupled with the plurality of core switches in the absence of the first stage patch panel. Said differently, as the networking system expands to include additional network ports (e.g., the network ports of the second network pod), the first stage patch panel may be removed or otherwise replaced by the second stage patch panel. In doing so, the second stage patch panel may be placed in an operational configuration in which the second stage patch panel is coupled with the plurality of core switches. In the operational configuration, the second stage patch panel may operatively couple the second set of network ports (e.g., the network ports of the second network pod and/or the first network pod) and a second portion of the plurality of core switches such that signals may pass therebetween.

In some embodiments, the second stage patch panel may operate to communicably couple the second set of network ports (e.g., the first network pod and the second network pod) with each of the core switches such that the second portion of the plurality of the core switches refers to each of the core switches. In some embodiments, the second stage patch panel may operate to communicably couple the second set of network ports (e.g., the first network pod and the second network pod) with a second portion of the core switches that is less than the total number of core switches.

Many modifications and other embodiments of the present disclosure will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

1. A scalable networking system, the system comprising:
a plurality of core switches; and
a first stage patch panel associated with operation of a first set of network ports,
wherein, in an operational configuration in which the first stage patch panel is coupled with the plurality of core switches, the first stage patch panel is configured to:
operatively couple the first set of network ports and a first portion of the plurality of core switches such that signals may pass therebetween; and
preclude communication to a remaining portion of the plurality of core switches.

2. The scalable networking system according to claim 1, wherein the plurality of core switches are commonly housed within a datacenter rack.

3. The scalable networking system according to claim 2, wherein the first stage patch panel is removably attached with the datacenter rack.

4. The scalable networking system according to claim 1, further comprising a second stage patch panel associated with operation of a second set of network ports.

5. The scalable networking system according to claim 4, wherein the second set of network ports includes at least a portion of the first set of network ports.

6. The scalable networking system according to claim 4, wherein the second stage patch panel is configured to be operatively coupled with the plurality of core switches in the absence of the first stage patch panel.

7. The scalable networking system according to claim 6, wherein, in an operational configuration in which the second stage patch panel is coupled with the plurality of core switches, the second stage patch panel is configured to:
operatively couple the second set of network ports and a second portion of the plurality of core switches such that signals may pass therebetween; and
preclude communication to a remaining portion of the plurality of core switches.

8. The scalable networking system according to claim 7, wherein the second portion of the plurality of core switches includes at least a portion of the first portion of the plurality of core switches.

9. The scalable networking system according to claim 1, wherein the first stage patch panel comprises a plurality of communication mediums configured to operatively couple the first set of network ports and the first portion of the plurality of core switches in the operational configuration.

10. The scalable networking system according to claim 9, wherein the plurality of communication mediums comprise optical fibers, electrical traces, and/or electrical wires.

11. A scalable patch panel for networking systems associated with operation of a first set of network ports, the patch panel comprising:
a plurality of communication mediums,
wherein, in an operational configuration in which the scalable patch panel is coupled with the plurality of core switches, the scalable patch panel is configured to:
operatively couple the first set of network ports and a first portion of a plurality of core switches such that signals may pass therebetween; and
preclude communication to a remaining portion of the plurality of core switches.

12. The scalable patch panel according to claim 11, wherein the scalable patch panel is configured for removable attachment with a datacenter rack housing the plurality of core switches.

13. The scalable patch panel according to claim 11, wherein the plurality of communication mediums comprise optical fibers.

14. The scalable patch panel according to claim 11, wherein the plurality of communication mediums comprise electrical traces or wires.

15. A method for scaling a networking system, the method comprising:
providing a plurality of core switches; and
operatively coupling a first stage patch panel associated with operation of a first set of network ports with the plurality of core switches, wherein, the first stage patch panel is configured to:
operatively couple the first set of network ports and a first portion of the plurality of core switches such that signals may pass therebetween; and
preclude communication to a remaining portion of the plurality of core switches.

16. The method according to claim 15, further comprising providing a second stage patch panel associated with operation of a second set of network ports.

17. The method according to claim 16, wherein the second set of network ports includes at least a portion of the first set of network ports.

18. The method according to claim 16, further comprising operatively coupling the second stage patch panel with the plurality of core switches in the absence of the first stage patch panel.

19. The method according to claim 18, wherein the second stage patch panel is configured to:
operatively couple the second set of network ports and a second portion of the plurality of core switches such that signals may pass therebetween; and
preclude communication to a remaining portion of the plurality of core switches.

20. The method according to claim 19, wherein the second portion of the plurality of core switches includes at least a portion of the first portion of the plurality of core switches.
